(19) United States
(12) Patent Application Publication
(10) Pub. No.: US 2018/0251292 A1
(43) Pub. Date: Sep. 6, 2018

(54) STRUCTURAL MODULES FOR LAYOUT OF MODULAR POWER PLANTS

(71) Applicant: Aruanã Energia S/A, Goiãnia GO (BR)

(72) Inventor: Sandro Marchini, Campinas, SP (BR)

(73) Assignee: Aruanã Energia S/A, Goiãnia GO7 (BR)

(21) Appl. No.: 15/508,843

(22) PCT Filed: Jan. 9, 2017
(86) PCT No.: PCT/BR2017/000004

§ 371 Date: Mar. 3, 2017

(30) Foreign Application Priority Data
Jul. 25, 2016 (BR) 10 2016 0171784

(51) Int. Cl. B65D 88/74; F02B 63/04; B65D 90/00; B65D 90/12

(52) U.S. Cl. CPC B65D 88/74; F02B 63/04; B65D 90/12; B65D 90/0026; B65D 90/0006

(57) ABSTRACT

Structural modules for layout of modular power plants are disclosed. The structural modules comprise a substation module and a power house module, basically formed by platforms having stringers and crossbars designed for the mounting of containment sheets. Both modules include interconnections including, for example, projecting tabs for the mechanical mounting of fixation elements enabling the connection between the modules and the mounting of columns, crossbars and lifting frame so as to form a structural skeleton suitable to contain the canopies, hinged doors and sliding doors and other mechanical structures making up the spatial areas designed for the installation of various equipment, such as a group of generators, fuel tanks and tanks for containment of liquids, motors, busbars. The substation module forms a support base whose stringers and crossbars are lined with containment sheets which, in turn, are secured by welds.

### TECHNICAL FIELD OF THE INVENTION

The present invention deals with improvements made to structural modules for the layout of modular power plants where in particular said structural modules comprise platforms provided with means of mechanical interconnection for the assembly of a group of columns/crossbars designed to make up a structure able to accommodate canopies, likewise secured mechanically via nuts and bolts, making up distinct modules such as: i) substation module and ii) power house module, laid out to form various models of modular power plants thereby assuring a reduction in fabrication costs of the plant, improved transport logistics by the distinct structural modules and flexibility in the product line for various layouts obtained by putting the structural modules together.

### HISTORY OF THE INVENTION

Modular generators or power plants provide great usefulness in the providing of electrical energy during the failure of the conventional distribution systems, chiefly in remote locales, hospitals, amusement parks, industries, various commercial establishments, areas in times of conflict, shopping centers, etc.

Generally speaking, such modular generators can be presented in ISO containers and canopies, housing motors, power houses with groups of generators, fuel tanks, equipment making up the cooling or refrigeration system, step-up substation, individual electrical columns of each generator group, low-voltage busbars, among other equipment and devices making possible the supplying of electrical energy.

The structure of the containers is of monobloc type, in particular being comprised of a platform of various dimensions for installation of the internal floor and a pair of lateral stringers for the mounting of the posts, in term equipped with corner units, end stops, and other devices enabling the mounting of the lateral, rear and upper panels, as well as the doors.

Despite the formation of the current modular plants in containers making up models of reduced dimension and high capacity for generation of electrical energy, allowing for applications in rapid and low cost installation projects, the structural characteristics of the monobloc containers impede the logistics of assembly of the modular plant, making the process more costly.

Another drawback of the current models lies in the fact that the monobloc design of the modular plants does not allow for the formation of new layouts of modular plants, limiting the conventional models which can be used for the adequate supply of electrical energy.

The applicant, operating in the field of production of modular power plants, has filed the document No. BR202013029267-8 which deals with a modular power plant having a high-voltage transformer system for direct connection to an energy distribution system, being integrated in containers or the like, said modular power plant being provided in a container of maritime ISO type of 20 or 40 feet, provided with noise control and composed of a group of integrated units able to generate medium-voltage energy for the supply of a local power distribution system, said units being defined as: i) generator units; cooling unit; distribution and transformer unit; in the internal portion of the container base there are built-in tanks enclosed by a double-wall for the containment of oil/contaminated water, while the cabin making up the cooling unit has air intakes to assist in the cooling and at least one pair of fans; said generator units can have four or two generators which, in turn, are operated by automotive gasoline, diesel, or biodiesel motors, each generator being connected to an exhaust gas line which is installed in the upper wall of the container.

Even though this model of a modular power plant has countless advantages in doing away with other auxiliary equipment for the connection to the power distribution system and optimized operability of the units, the structure where the units are integrated is unique, preventing the formation of new layouts of modular plants.

### Analysis of the Prior Art

In a search of specialized databases there were found documents pertaining to modular power plants, such as document No. BR102012021603-5 which deals with a transportable modular micro thermoelectric plant and a process for generation of compact electrical energy, comprised of dismountable and connectible modules, and being movable, able to be installed in both urban zones and rural zones, maritime, industrial and residential zones, thanks to its easy mobility.

Document No. PI 0605454-4 discloses a mobile generator composed of two cells contained in a main body, made from a container which internally houses a platfoiiu on which are positioned two motors having an electronic injection system, fueled by diesel, pure biodiesel or that mixed with diesel, packaged in a fuel tank arranged in the rear section, while the front section contains at the bottom a power house above which there is located a control panel, said container being provided with doors in its lateral sections and front section.

As noted, despite the aforementioned searched documents dealing with modular power plants, the design characteristics of the subject matter herein proposed is different from the characteristics presented in the documents, thus ensuring that it meets the legal requirements for patent worthiness.

### PURPOSES OF THE INVENTION

Given the aforementioned problems of the prior art, it is clear that the need still exists of developing a structural module making possible the formation of various layouts of modular power plants.

Said structural modules comprise platforms provided with means of interconnection for the formation of a group of columns and crossbars so as to compose a structural skeleton for the mounting of canopies, likewise being attached mechanically through nuts and bolts, making up a substation module and a power module.

Said means of interconnection basically comprise areas and projecting tabs provided with perforations for the mechanical mounting of fixation bolts, nuts, or other elements adequate for fixation.

Both the substation module and the power house module are fabricated individually, and also the power house module provides a lifting distribution frame which facilitates the logistics during the assembly of the modular power plant.

One of the main advantages of the present invention lies in the fact that the means of mechanical interconnection enable more flexibility on the assembly line of the modular plants, which can be laid out in practical form, allowing the formation of plants with two generator groups comprised of a substation and control module and a power module or a modular plant composed of four generator groups formed by a substation and control module and two power modules, among other layouts.

Another advantage lies in the fact of the reduced dimensions of each module, which facilitate and reduce the cost of fabrication of the modular plant.

Another advantage lies in the fact that the modular plant can be transported in parts thanks to the movement of the different modules whose reduced weight minimizes the size of the crane needed to remove them from the truck and install them in the field.

As an example, an assembled modular plant has a weight of around 30 T, requiring the use of a crane greater than 30 T in order to move it, while each loose module making up a modular plant can be moved by an ordinary Munck truck, which is much more economical for the rental.

### DESCRIPTION OF THE DRAWINGS

As a supplement to the present specification, in order to obtain a better comprehension of the characteristics of the present invention and in accordance with a preferred practical embodiment of same, the specification is accompanied by an enclosed set of drawings, representing its functioning in exemplary, but not limiting manner:

FIG. 1 represents a perspective view of a layout with power and substation modules;

FIGS. 2, 2 A, 2B, 2C and 2D represent details ‘A’, ‘B’, ‘C’, ‘D’ and ‘E’ as indicated in the previous figure;

FIGS. 3 and 3A illustrate side and top views of the layout illustrated in FIG. 1;

FIG. 4 shows a perspective view of the platform of the power module with respective columns and crossbars in exploded view;

FIGS. 5, 5A and 5B show top view and transverse A.A and longitudinal B.B section views of the platform making up the power module; and

FIGS. 6, 6A and 6B represent perspective and side views of a layout of structural modules for producing a model of an assembled modular plant.

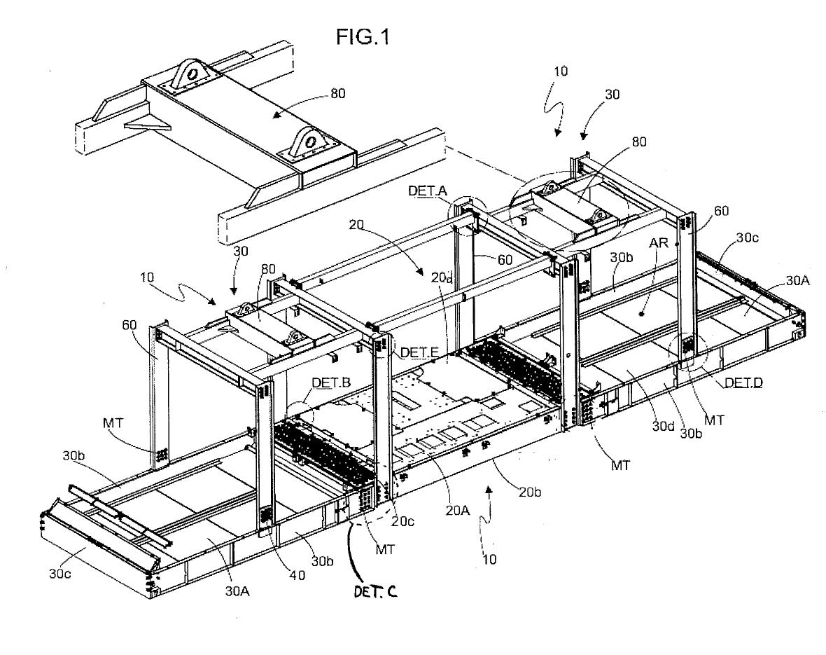

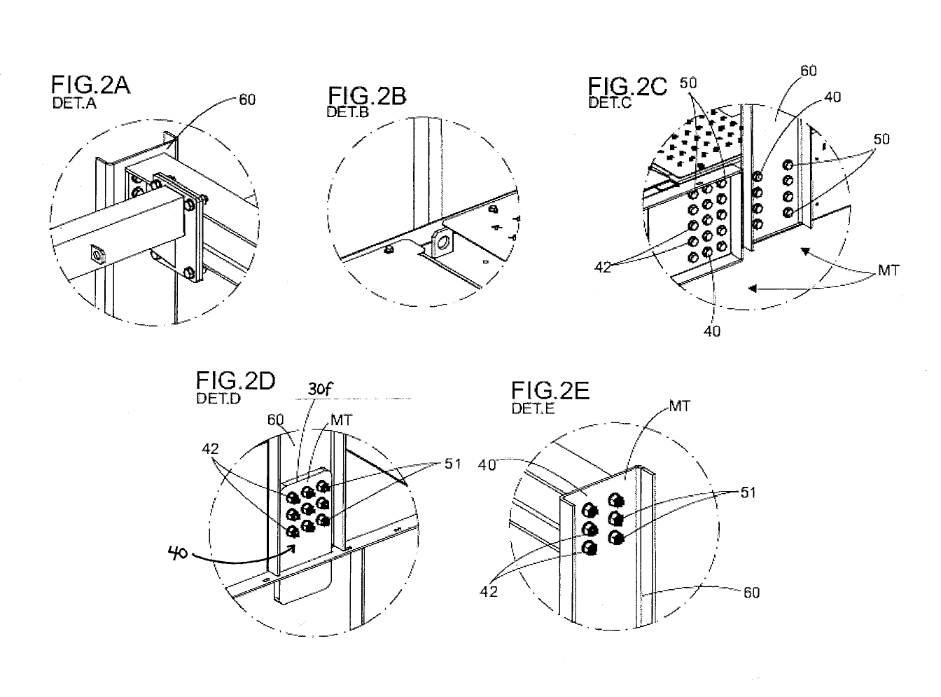

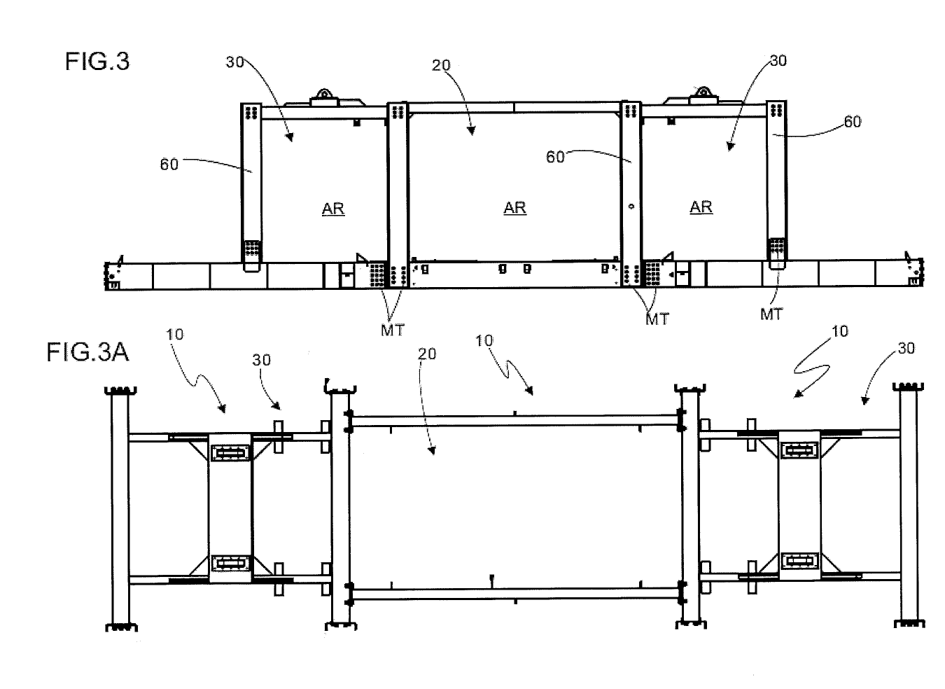

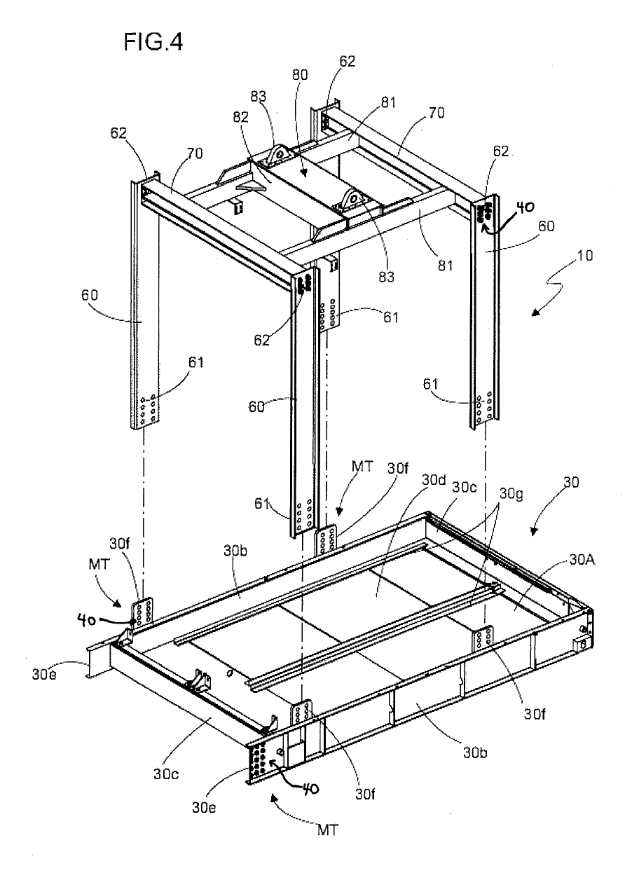

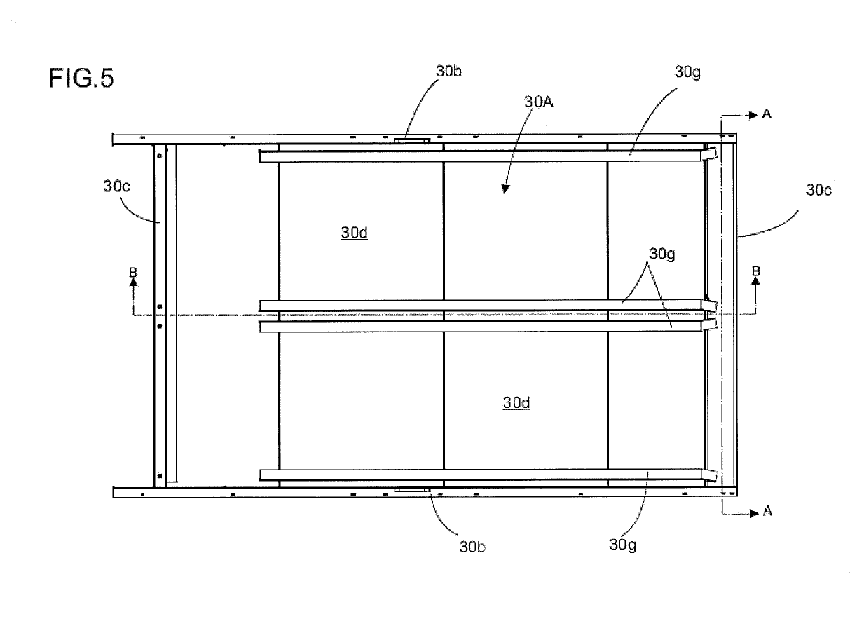

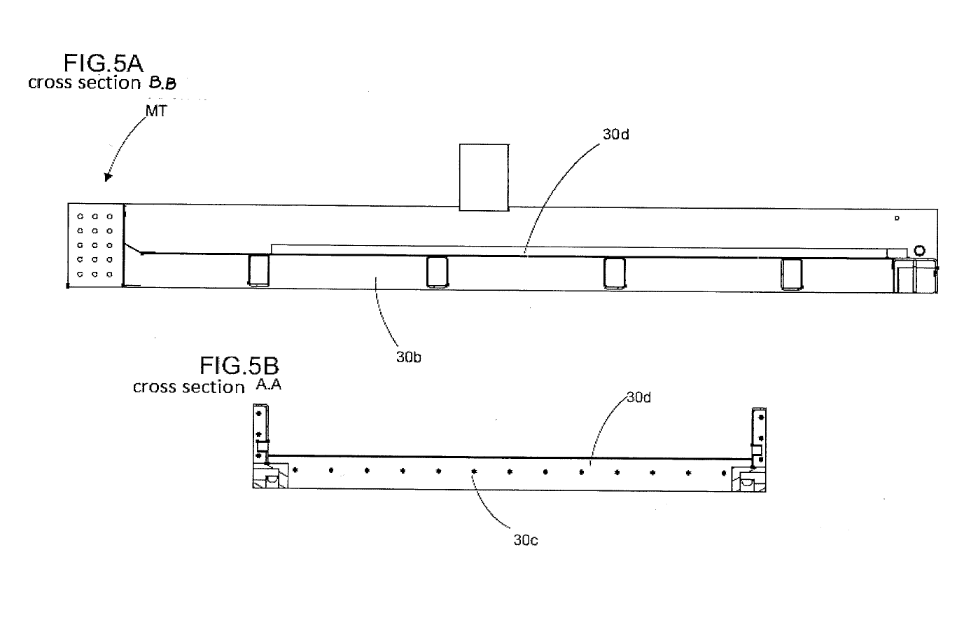

### DESCRIPTION OF THE INVENTION

With reference to the illustrated drawings, the present patent of invention pertains to “IMPROVEMENTS MADE TO STRUCTURAL MODULES FOR LAYOUT OF MODULAR POWER PLANTS”, more precisely it deals with structural modules (10) for composing a layout of modular power plants (US) of the type used to supply energy in various areas, such as isolated rural and mining communities, oil drilling platforms, hospitals, industries, among other locations.

According to the present invention, said structural modules (10) comprise a substation module (20) and a power house module (30), basically formed by platforms (20A) and (30A) having stringers (20b)/(30b) and crossbars (20c)/(30c) designed for the mounting of containment sheets (20d)/(30d), both the platfoini (20) and the platform (30) having means of interconnection (MT) formed by areas (40) and projecting tabs (41) provided with perforations (42) for the mechanical mounting of fixation bolts (50), nuts (51) or other adequate element enabling the connection between the platforms (20)/(30) and the mounting of columns (60), crossbars (70) and lifting frame (80) so as to fonn a structural skeleton (AR) suitable to contain the canopies (CP), hinged doors (PT1) and sliding doors (PT2) and other mechanical structures making up the spatial areas (AR) designed for the installation of various equipment (not shown), such as a group of generators, fuel tanks and tanks for containment of liquids, motors, busbars, among others.

In a preferred design, the substation module (20) forms a support base for the control panel (PC) whose stringers (20b) and crossbars (20c) are lined with sheets (20d) which, in turn, are secured by welds.

The power house module (30) comprises a platfolui (30A) whose stringers (30b) have, at one of the free ends, prolongations (30e) provided with means of interconnection (MT) forming areas (40) with perforations (42) for the mechanical mounting of fixation bolts (50) and nuts (51), and also near the top of both said stringers (30b) there are provided projecting tabs (30f), also having means of interconnection (MT). On the upper surfaces of the containment sheets (30d) are installed longitudinal guides (30g) formed by L-profiles.

Said platform (30) receives, in the areas (40), the connection portions (61) of the columns (60), which in turn have a C-shaped cross section and on whose planar surface are provided said areas (40) for the mounting of the bolts (50), preferably ASTM 325, and heavy-duty hexagonal nut (51) ASTM A194.

In the areas (40) of the upper free ends (62) of each column (60) are mounted, mechanically and transversely, crossbars (70) whose profile has a U-shape where, in turn, are installed free ends of bars (81) of said lifting distribution frame (80).

The bars (81) of the frame (80) support a beam (82) in whose end portions and planar surface are installed handles (83) for attachment of hooks (not shown) and lifting of the module (30).

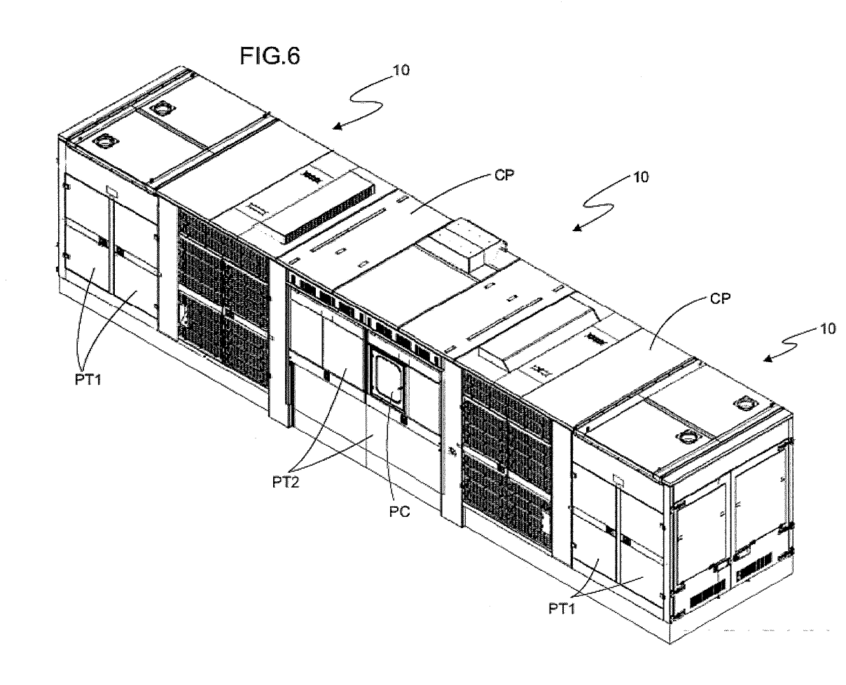

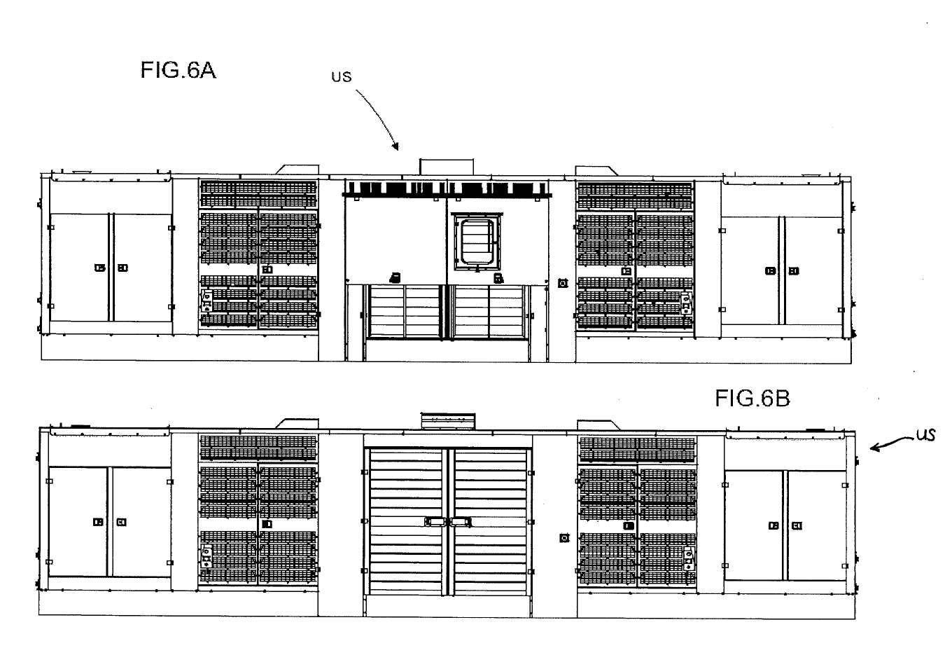

Thus, the means of interconnection (MT) of the modules (20) and (30), formed by mechanical mounting of bolts (50) and nuts (51), enable the layout of compound modular plants (10), such as a layout formed by two groups of generators (see FIGS. 6, 6A and 6B) obtained by a substation and control module (20) with a power module (30) or four groups of generators formed by a substation and control module (20) with two power modules (30).

It is certain that if the present invention is put into practice modifications could be made in regard to certain details of construction and shape, without this meaning a departure from the fundamental principles which are clearly substantiated in the claims, it being thus understood that the terminology used does not have a limiting purpose.

1. A modular power plant for supplying electricity, the modular power plant comprising:
a substation module comprising a substation module platform, wherein the substation module platform comprises a substation module stringer and a substation module crossbar;
a power house module comprising a power house module platform, wherein the power house module platform comprises a power house module stringer and a power house module crossbar; and
an interconnection mechanism, wherein the interconnection mechanism comprises a tab comprising an interconnection area, and wherein the tab connects a structural element with a corresponding one of the substation module stringer, the substation module crossbar, the power house module stringer, or the power house module crossbar;
wherein the substation module stringer, the substation module crossbar, the power house module stringer, or the power house module crossbar comprises a tab insertion slot configured to mount the tab therein.

2. A modular power plant for supplying electricity, the modular power plant comprising:
a substation module comprising a substation module platform, wherein the substation module platform comprises a substation module stringer;
a power house module comprising a power house module platform, wherein the power house module platform comprises a power house module stringer having a prolongation at an end thereof; and
an interconnection mechanism, wherein the interconnection mechanism comprises an interconnection area located on the prolongation of the power house module stringer, and wherein the interconnection mechanism connects the power house module stringer with the substation module stringer.

3-4. (canceled)

5. The modular power plant of claim 1, wherein the substation module stringer or the power house module stringer comprises the tab insertion slot.

6. The modular power plant of claim 1, wherein the tab insertion slot is located on a top surface of the substation module stringer, the substation module crossbar, the power house module stringer, or the power house module crossbar.

7. The modular power plant of claim 6, wherein the structural element comprises a column.

8. The modular power plant of claim 7, wherein a connection portion of the column at least partially surrounds the tab.

9. The modular power plant of claim 8, wherein the connection portion has a C-shaped cross-section.

10. The modular power plant of claim 1, wherein the substation module stringer and substation module crossbar are configured to support a substation module containment sheet.

11. The modular power plant of claim 1, wherein the power house module stringer and power house module crossbar are configured to support a power house module containment sheet.

12. The modular power plant of claim 1, wherein the interconnection area comprises perforations configured to accommodate bolts and nuts.

13. The modular power plant of claim 1, wherein the modular power plant comprises at least two power house modules.

14. The modular power plant of claim 2, wherein the substation module platform further comprises a substation module crossbar, and wherein the substation module stringer and substation module crossbar are configured to support a substation module containment sheet.

15. The modular power plant of claim 2, wherein the power house module platform further comprises a power house module crossbar, and wherein the power house module stringer and power house module crossbar are configured to support a power house module containment sheet.

16. The modular power plant of claim 2, wherein the interconnection area comprises perforations configured to accommodate bolts and nuts.

17. The modular power plant of claim 2, wherein the modular power plant comprises at least two power house modules.

18. A modular power plant for supplying electricity, the modular power plant comprising:
a substation module comprising a substation module platform, wherein the substation module platform comprises a substation module stringer and a substation module crossbar; and
a power house module comprising:
a power house module platform, wherein the power house module platform comprises two power house module stringers and a power house module crossbar;
two pairs of columns connected to the two power house module stringers via lower ends of the columns; and
upper ends of the columns comprising interconnection areas for connecting a lifting distribution frame crossbar between each pair of columns, wherein each lifting distribution frame crossbar is connected to free ends of two bars of a lifting distribution frame, wherein the two bars support a beam therebetween, and wherein the beam comprises an attachment mechanism configured to lift the power house module.

19. The modular power plant of claim 18, wherein each lifting distribution frame crossbar has a U-Shaped profile.

20. The modular power plant of claim 18, wherein the attachment mechanism comprises at least one handle, each handle configured to be attached to a hook to lift the power house module.

21. The modular power plant of claim 18, wherein the attachment mechanism comprises two attachment mechanisms which are positioned at end portions of the beam.

22. The modular power plant of claim 18, wherein the modular power plant comprises at least two power house modules.
